(19) United States
(12) Patent Application Publication
(10) Pub. No.: US 2004/0137131 A1
(43) Pub. Date: Jul. 15, 2004

(54) Maca products and their uses

(76) Inventor: Paul J. Bobrowski, Scottsdale, AZ (US)

Correspondence Address: ELLIS & VENABLE, PC, 101 NORTH FIRST AVE., SUITE 1875, PHOENIX, AZ, 85003, US

(21) Appl. No.: 10/676,459

(22) Filed: Sep. 30, 2003

Related U.S. Application Data
(63) Continuation-in-part of application No. 09/655,598, filed on Sep. 5, 2000, now abandoned.
(60) Provisional application No. 60/152,468, filed on Sep. 3, 1999.

(51) Int. Cl. A23K 1/00

(52) U.S. Cl. 426/615

(57) ABSTRACT

An extract and procedure for extracting the polar components from plants of the Family Brassicaceae, specifically but not limited to the genus Lepidium. The extraction has an increased polar and decreased lipidic constituent concentration with an increased pharmacocological ability to affect growth parameters relative to the parent material. The concentration of polar constituents makes the product more amenable to preparations that increase growth parameters in aquaculture.

This application claims benefit of U.S. patent application Ser. No. 09/655,598 filed on Sep. 5, 2000 and U.S. Provisional Application No. 60/152,468, filed on Sep. 3, 1999.

### BACKGROUND OF THE INVENTION

Field of the Invention

“Maca” is the common name for the South American cruciferous vegetable Lepidium meyenii (or L. peruvianum Chacon). It is believed to have been first domesticated during the Archaic Period and as reported by the conquistadores in the 16^{th} century, was cultivated and used by the Inca as a dietary staple and an animal foodstuff.

In 1653 Padre Bernabe Cobo published Historia del Nuevo Mundo, his first-person account of the conquest, describing Maca's use in the empire's culture. It was reported that when altitude-induced reproductive problems arose in Spanish domesticates transplanted from the New World, the condition was ameliorated with a diet of Maca. As such, Maca was imported into Spain for Queen Isabella several years before the potato's introduction into Europe.

However, Maca is not employed in old world agriculture as is the potato (Solanum tuberosum) and other South American crops like tomatoes (Lycopersicum esculentum) and maize (Zea mais). Maca is not related to these common crops, but as a member of the Brassicaceae or “broccoli” family, is the only true crucifer of the Americas.

Western 20^{th} century society “rediscovered” Maca in its screening of South American medicinal plants as potential new sources to combat modern disease. Padre Corba's report (as well as that of others) and its purported local use and popularity as an aphrodisiac, prompted an interest and its growth in the international dietary supplement industry.

Thus, modern research has primarily centered upon analyzing it applications to enhance human sexual performance. As such, of the eight peer-reviewed human or animal studies recognized in the US National Library of Medicine's Index Medicus, seven involve male sexual performance and/or endocrine function related to sexual performance.

In adult males (human), daily supplementation with 1,500 or 3,000 milligrams of Maca over a 3 to 4 month period was shown to increase sexual desire and semen parameters without affecting serum reproductive hormone levels (Gonzales 2001; Gonzales 2002; Gonzales 2003). In male rats, Maca (or its extracts) supplementation improved sexual performance, increased testicular and epididymis weight as well as semen parameters (Cicero 2002; Gonzales 2001; Cicero 2001; Zheng 2000).

However, traditionally Maca was cultivated foremost for its nutritive value for humans as well as their domesticates. It grew at altitudes where in many cases it was the only source of nutrition available and as such became a staple to the indigenous peoples.

In addition to historical reports, there are modern accounts of increased growth rates as well as increases in fertility and procreation in both male and female domesticates (i.e. pigs, cows) fed Maca. These have occurred without the addition of synthetic steroid hormones to supplement growth, as is common practice in modern animal husbandry.

Intrauterine Growth Restriction (IUGR) can result from a variety of intrinsic fetal factors (e.g. infections, congenital defects, inborn errors of metabolism) or extrinsic factors (e.g. environmental, maternal, placental) with growth usually compromised into adulthood. One such well recognized, studied and reported environmental factor is that a high altitude environment results in fetal growth restriction and compromised fertility. For every 1000 feet above sea level there is a reduction of birth weight by 100 g, due to third trimester growth restriction. However, for the indigenous Andeans who flourished above 10,000 feet, Maca appears to have ameliorated growth restrictions associated with high altitude living.

The traditional nutritive uses of Maca, while with practical application both in humans and other animals, are constrained by several factors. Primarily, nutritive effects require large doses which are limited by availability. Although archeological evidence suggests expansive Pre-Columbian cultivation in both Central and South America, today Maca is only found in the Puna region of the Andean Mountains of Peru at altitudes greater than 3,600 meters (12,000 feet).

A means of reducing and quantifying the quantity of Maca required to effect a positive change in growth and fecundity in animals would represent a significant improvement over the traditional use of the botanical and allow for more widespread and practical application.

### SUMMARY OF THE INVENTION

Aspects of the invention are summarized below to aid in the understanding of embodiment(s) of the invention and the application. Yet, the invention is fully defined by the claims of the application.

Maca is the common name for Lepidium meyenii, an ancient crucifer indigenous to the Andean plateaus of Peru. Traditionally, it was domesticated and used primarily for its nutritive value, as an altitude “adaptogen,” for vitality and secondarily for its reproductive and sexual enhancement properties. However, while effective for growth and increased fecundity, the quantity of Maca required compared to the quantity available severely limits its use.

The present invention generally comprises compositions that retain the ability to positively effect growth and fecundity in animals despite a significantly limited and reduced amount of Maca when compared to traditional applications. The compositions contained herein increased growth rate, survival and biomass when tested in commercial pisciculture without the addition of synthetic steroid hormones.

Whilst the compositions retain their desirable properties, the reduced quantity of Maca required to elicit a favorable response offers significant improvement over traditional and current applications, commercially and financially amenable for use in animal husbandry.

While a prior art exists for the extraction of Maca for its lipidic constituents using organic solvents for enhancing activities associated with sexual function, these components elicit no bioactivity regarding increased growth, survival or biomass. In contrast, the herein described extract where small polar constituents are isolated with methanol that promotes growth, survival and biomass in animals would be of great value.

The compositions are incorporated into biologically active dosage units forming beneficial growth-enhancing compositions.

### BRIEF DESCRIPTION OF THE FIGURES

FIG. 1: The Effects of Maca supplementation on the Growth of Rainbow Trout Alevins. Maca significantly accelerated growth from 8 weeks and beyond. While 10 and 15% Maca were significantly (P<0.05) more effective than 5% Maca or controls, there was no difference between the 10 and 15% maca groups. Mean±SD.

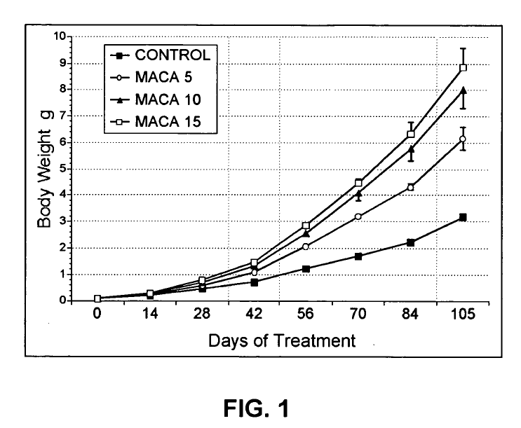

FIG. 2: Maca and Survivability of Rainbow Trout Alevins. Dietary supplementation with Maca resulted in improved survival of trout Alevins.

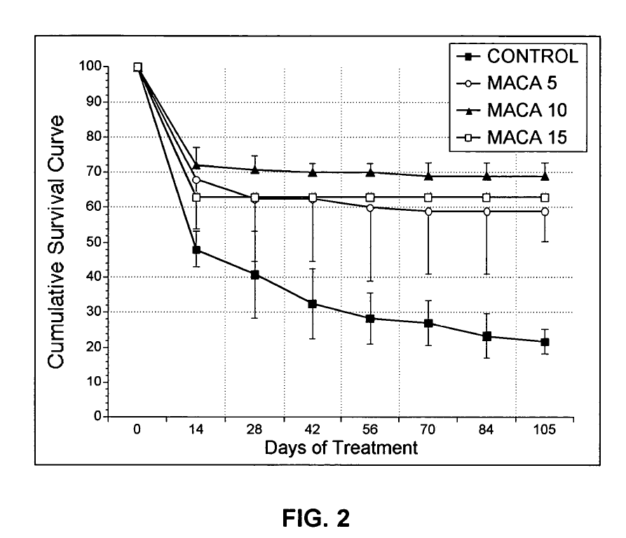

FIG. 3: Increased Protein Efficiency Ratio In Trout Fed Maca Supplemented Feeds. The significantly enhanced conversion of feed into protein is highly suggestive of an anabolic action of maca.

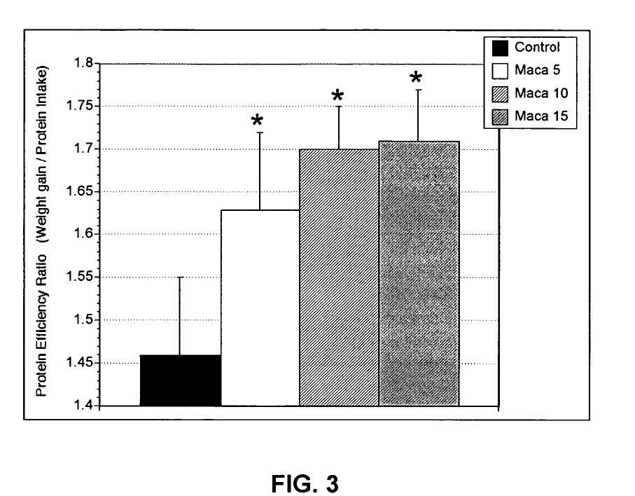

FIG. 4: Increased Fish Biomass With Maca Supplementation. This reflects the combined actions on growth and enhanced survival in this transition period.

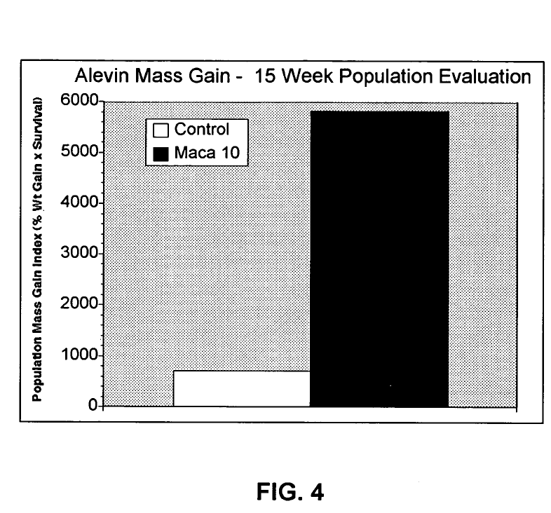

FIG. 5: Comparison Of Lipidic And Methanol Extracts Of Maca On Trout Growth. Only the Maca control and methanol extract promoted growth.

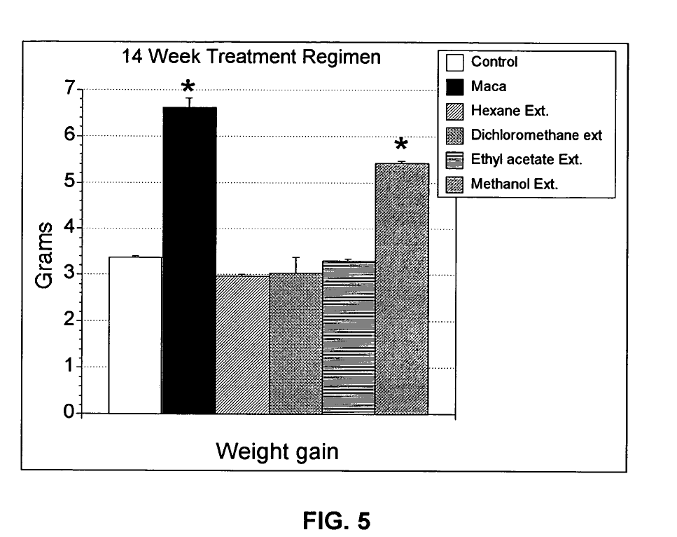

FIG. 6: Maca Extracts On Survival And Biomass. A methanol extract mimicked Maca in terms of enhanced survival and increased biomass, whereas lipid extracts were ineffective.

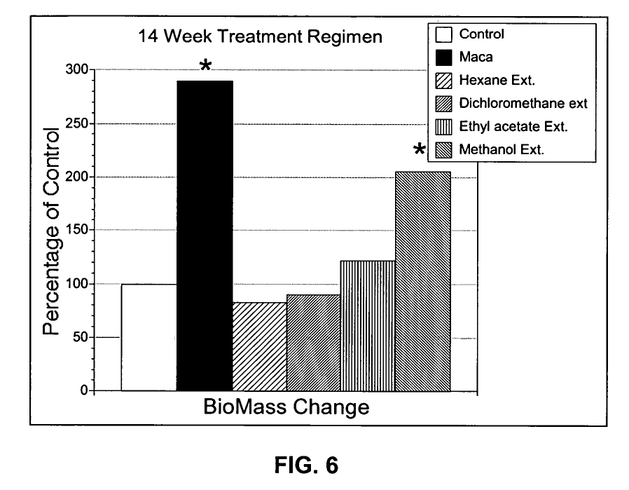

### DESCRIPTION OF AN EMBODIMENT

Extraction Procedure

According to one aspect of this invention, a process that concentrates polar components optimizes the extraction of Lepidium species for anabolism and enhanced survival. This extraction process concentrates maca by reducing its mass by 95%, selecting for polar constituents, independent of lipophilic constituents, and results in enhanced growth parameters and hence is amenable to health and veterinary care preparations. Preferred methods to accomplish the aforementioned Lepidium species extraction are described by the procedures below but it is contemplated that a skilled practitioner could device obvious variations of the procedures given the disclosure herein and the desired results.

Extraction Process 1.

Maca hypocotyls are harvested, cleaned, washed and macerated. The macerate is mixed with an alcohol. The preferred alcohol is methanol although other alcohols can be used as would be obvious to the ordinarily skilled practitioner in light of the disclosure herein. The alcohol is added to the macerate in a 3:1 weight:

weight proportion. In the preferred extraction process the macerate mixture is agitated.

The preferred agitation method is stirring although other agitation methods are also contemplated to be effective. This agitation can be accomplished concurrent with heating. Following, the mixture is filtered to remove particulate components by standard methods or other techniques known to separate particulates. Actual laboratory procedures achieved acceptable results using a Whatman #4 filter paper or an equivalent.

The polar bioactive materials are solutes contained within the alcoholic solvent, which are concentrated by evaporation of the solvent by one of several procedures, such as vacuum drying, freeze drying or heating. Actual heating up to 40 degrees Celsius produced acceptable drying results.

The remaining alcohol extract is composed of polar bioactive materials, representing the active constituent.

Extraction Process 2.

Maca hypocotyls are harvested, cleaned and washed repeatedly with water to remove all detritus materials. The water content is then depleted through drying from the prepared hypocotyls to a moisture content of between 1 and 12 percent.

The preferred method of drying is by heating to a temperature of between 35 and 95 degrees Celsius for a period of between 24 to 48 hours although other drying methods are also contemplated to be effective. The dried hypocotyls are then ground into a coarse or fine powder. The powder is further processed pursuant to the disclosure herein to create end products comprising biologically active doses in the forms and for the purposes disclosed herein.

Extraction Process 3.

Maca hypocotyls are harvested, cleaned and washed repeatedly with water to emove all detritus materials. The water is then extracted through drying from the repared hypocotyls to a moisture content of between 1 and 12 percent.

The drying and subsequent preparation of the hypocotyls into a powder is consistent with methods outlined in Extraction 2. The powder is then mixed with an alcohol.

The preferred alcohol is methanol although other alcohols can be used as would be obvious to the ordinarily skilled practitioner in light of the disclosure herein. The alcohol is added to the powder in a 3:1 weight: weight proportion and then prepared consistent with methods outlined in Extraction 1.

The extraction methods herein described produce a material that is characterized by an increase in polar constituents independent of lipidic components, as well as insoluble protein and carbohydrate material. When compared to the parent botanical, these active polar constituents reduces the amount of material required for bioactive and growth enhancing effects of the parent botanical by 95%, and is amenable to health and veterinary care applications.

Increased Growth Rate

Animal growth is influenced by external factors like nutrition and the environment, and this is particularly true for ectotherms such as teleost fish, where temperature, light, and nutrition can trigger developmental processes. Thus, we conducted a study to evaluate the effects of Maca supplementation on the growth of rainbow trout allevins (hatchlings transitioning from a yolk sac source of nutrition to meals) in commercial aquaculture. Alevins were offered a semi-purified, a casein-elatin gelatin based, control diet or diets where wheat meal was replaced by 5, 10 or 15% of Maca meal.

The addition of Maca significantly increased the growth rate of Trout Allevins (7.7±1.4 g in Maca-supplemented groups versus 3.2±0.2 g in control).

Increased Survivability

We conducted a study to evaluate the effects of Maca supplementation on the survivability of trout allevins in commercial aquaculture.

Dietary supplementation with Maca resulted in improved survival of trout allevins. All Maca groups were effective when compared to controls (P<0.05) but there was no evidence of a dose-dependent effect as individual Maca groups were indistinguishable from each other, although variability was substantial in the −5% group. High mortality in control groups fed a purified diet as the first food is not unusual, as mortality is common in this transition period.

In this study, whole body proximate analyses revealed significant reductions in water content, ash, phosphorus, zinc and calcium in Maca fed fish. Protein, lipid, potassium and magnesium were not significantly affected. A noted increased leukocyte count in Maca fed animals may reflect an improved immunity, which may contribute to the improvements in survival.

Increased Protein Efficiency Ratio

We conducted a study to evaluate the effects of Maca supplementation on the protein efficiency ratio (PER) of trout allevins in commercial aquaculture.

Supplementation with Maca consistently increased the feed conversion ratio by approximately 25% independent of age/maturation at the time of intervention. Maca was able to produce a corresponding 25% greater increase in animal weight per unit of feed—a more efficient use of nutritional resources. In the aquaculture industry this is a critical finding for commercial development.

Increased Biomass

We conducted a study to evaluate the effects of Maca supplementation on biomass of trout allevins in commercial aquaculture. Biomass is a term used to refer to the combined actions of growth and survivability.

Supplementation with Maca significantly increased allevins biomass.

Increased Growth, Survivability, Biomass with Methanol but not Lipidic Extractions of Maca

Lipidic extractions of Maca using organic solvents have been shown to isolate components, which may increase sperm parameters and sexual performance. However, it is unknown whether these extracts also affect growth parameters.

To study and compare the effects of lipidic versus methanol extracts of Maca, trout allevins were supplemented with diets containing a control diet, a Maca supplemented diet or a diet supplemented with concentrations of either a lipidic or methanol extract of Maca.

The methanol extract mimicked Maca in terms of enhanced survival and increased biomass whereas lipid extracts were ineffective. Only the Maca control and methanol extract promoted growth, indicating that the bioactive material is likely to be a small, non-polar material. Extracts prepared with organic solvents (hexane, dichloromethane, ethyl acetate) did not enhance growth. Similarly, the methanol extract mimicked Maca in terms of enhanced survival and increased biomass whereas lipid extracts were ineffective.

Although the invention has been described in detail with reference to one or more particular preferred embodiments, persons possessing ordinary skill in the art to which this invention pertains will appreciate that various modifications and enhancements may be made without departing from the spirit and scope of the claims that follow.

What is claimed is:

1. A method of extracting or concentrating the polar constituents from plants of the family Brassicaceae, comprising:
combining plant material from the Family Brassicaceae and with an alcohol solvent;
agitating the combination;
filtering the combination to resolve an alcohol remnant substantially higher in polar components and lower in lipidic components than the plant material; and
evaporating the alcohol to resolve the polar components.

2. The method of claim 1 wherein the plant material is the hypocotyls of the family Brassicaceae.

3. The method of claim 1 wherein the plant is of the genus Lepidium.

4. The method of claim 1 wherein the method further comprises,
washing, drying, and grinding the plant material, prior to the step of combining with the alcohol solvent.

5. The method of claim 4 wherein the drying of the plant material is selected from the dyring methods consisting of, evaporation and heating.

6. The method of claim 4 wherein the final moisture content of the washed, dried, and ground plant material is about between 1 and 20 percent.

7. The method of claim 1 where the alcohol solvent is Methanol.

8. The method of claim 1 wherein the plant material is combined with an alcohol in a 1:4 ratio

9. The method of claim 1 where the step of agitation comprises stirring.

10. The method of claim 1 where the step of agitation may be accompanied with heating.

11. The method of claim 1 where the step of filtring comprises filtering with at least two filters having a progressive decrease in pore size.

12. The method in claim 1 where the plant material is first placed in a bag comprising a porous filter material, and then combined with an alcohol solvent.

13. The method of claim 1 where the plant material may be macerated and then combined with an alcohol solvent.

14. The method of claim 1 wherein the step of evaporating the alcohol remnant to resolve the polar components is selected from the group of evaporating method consisting of; evaporation, heating, spray drying, freeze drying, and vacuum drying.

15. The method of claim 1 wherein the polar components are concentrated and the lipidic components reduced relative to the parent plant material.

16. An extract of family Brassicaceae, comprising:
a pharmaceutical dosage unit with concentrated polar components relative to the lipidic components.

17. The extract in claim 16 wherein the pharmaceutical dosage unit increases the growth of fish.

18. The extract in claim 16 wherein the pharmaceutical dosage unit increases the survivability of fish.

19. The extract in claim 16 wherein the pharmaceutical dosage unit increases the biomass of fish.

20. The extract in claim 16 wherein the pharmaceutical dosage unit increases the feed conversion ratio of fish.

21. The extract in claim 16 wherein the pharmaceutical dosage unit further comprises cereal grains.

22. The extract in claim 21 wherein the pharmaceutical dosage unit further comprises vitamins.

23. The extract in claim 21 wherein the pharmaceutical dosage unit is in the form a fish food selected from the group consisting of, pellets and fish meal.
